(19) United States
(12) Patent Application Publication
(10) Pub. No.: US 2005/0071636 A1
(43) Pub. Date: Mar. 31, 2005

(54) Home network device, home network system and method for automating take ownership process

(75) Inventors: Sung-min Lee, Seoul (KR); Hyun-gyoo Yook, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/950,946

(22) Filed: Sep. 28, 2004

(30) Foreign Application Priority Data
Sep. 29, 2003 (KR) 10-2003-0067408

(51) Int. Cl. H04L 9/00

(52) U.S. Cl. 713/170; 713/155

(57) ABSTRACT

A network device for automating a TakeOwnership process includes a public key generation unit for generating a public key and a private key by employing public key cryptography, a storage medium write/read unit for writing the generated public and private keys on a storage medium and for reading the public and private keys written on the storage medium, and a control point/security console switching unit for selecting one of a security console function providing an access authority for a predetermined device and a control point function controlling operation of the predetermined device, after authentication of a user using the private key stored on the storage medium. Thus, by employing public key cryptography in which a digital signature is created using the private key stored on the storage medium, such as a smart card, and is verified by the public key, the user can securely operate home network equipment as well as enjoy a convenience in use.

### BACKGROUND OF THE INVENTION

This application claims priority from Korean Patent Application No. 10-2003-0067408 filed on Sep. 29, 2003 with the Korean Intellectual Property Office, the disclosure of which is incorporated herein in its entirety by reference.

1. Field of the Invention

The present invention relates generally to a home network device, a home network system and a method for automating a TakeOwnership process. The present invention relates more particularly to a home network device, a home network system and a method for automating a TakeOwnership process, wherein a user may use home network equipment securely by employing public key cryptography and the home network and system are capable of authenticating the ownership thereof by performing an automatic TakeOwnership process by using a pair of public keys stored on a secure storage medium as a pair of public keys of a security console (SC).

2. Description of the Related Art

FIG. 1 illustrates a conventional password-based TakeOwnership process. At least one security console 10, a control point (CP) 20 and at least one device (D) 30 are involved in the TakeOwnership process, wherein the security console is adapted to allow a user to establish his ownership for the device, the control point controls the device, and the device provides contents and functions as a server.

To begin with, with respect to the TakeOwnership process, the security console 10, the control point 20 and the device 30 inherently store therein respective public key pairs when they were manufactured by manufacturers. Especially, on the device 30 is recorded an accessible password for the TakeOwnership process, and the password is informed to a purchaser who has bought the device.

After purchase, the purchaser or user connects the device 30 to a home network, and registers his ownership for the device 30 using the security console 10. Here, the user directly inputs password information into the security console, and then the input password information is transmitted to the device 30. The device 30 verifies the transmitted password information and then implements the TakeOwnership process.

Next, the security console 10 takes ownership for the device 30 as a result of implementing the TakeOwnership process. Specifically, when the user has one or more security consoles 10 in his/her home for the sake of convenience, one of the security consoles 10 may take ownership for new devices 31, 32 and 33, and each device has a hash value for the public key of the security console which has an authority to edit an access control list (hereinafter referred to as an “ACL”) of the new devices. In other words, in the process of implementing the TakeOwnership process, if a password represented through a specific security console is valid, the device 30 calculates the hash value for the public key of the security console, and stores the calculated hash value in order to certify which owner has an authority to edit the ACL of the new devices.

However, there are problems in that the user suffers from inconvenience in manually inputting passwords so as to take ownership for each device, and that when the user wants to use a plurality of security consoles, the user needs to purchase a corresponding number of equipment. When the plurality of security consoles are used, corresponding different keys must be used, so the user needs to remember the corresponding relationship between the devices and the security consoles in implementing the TakeOwnership process.

In other words, because the conventional password-based authentication method is vulnerable to a Brute Force Attack, and because the public key of the security console is transmitted together with a digital signature, it is difficult to confirm authenticity of the public key of the security console. Also, it may not be possible to authenticate a message sender. Further, there is an inconvenience that in order to set an access control for specific devices, the user has not only to remember the security console having the authority to edit the ACL of the specific devices, but also to manually input passwords provided by the manufacturer into each device through the security console so as to implement the TakeOwnership process.

### SUMMARY OF THE INVENTION

Accordingly, the present invention is made to solve the above-mentioned problems occurring in the related art, but embodiments of the present invention are not required to solve any of the specific problems described herein. An exemplary objective of the present invention is to provide a home network device, a home network system and a method for automating a TakeOwnership process, which are capable of securely operating home network equipment by employing public key cryptography and of automatically implementing the TakeOwnership process.

It is another exemplary objective of the present invention to provide a home network device, a home network system and a method for automating a TakeOwnership process, in which a control point can simultaneously perform a security console function by which the control point has an authority for access to at least one controlled device.

Consistent with an exemplary embodiment of the present invention, there is provided a network device for automating a TakeOwnership process, which comprises a public key generation unit, a storage medium write/read unit and a control point/security console (CP/SC) switching unit. The public key generation unit generates a public key and a private key by employing public key cryptography. The storage medium write/read unit is for writing the generated public and private keys on a storage medium and for reading the public and private keys written on the storage medium. The control point/security console (CP/SC) switching unit selects any one of a security console function and a control point function after authentication of a user using the private key stored on the storage medium, wherein the security console function provides an access authority for a predetermined device and the control point function controls operation of the predetermined device.

Consistent with another exemplary embodiment of the present invention, there is provided a network device for automating a TakeOwnership process. The network device comprises a storage medium read unit for reading a first public key generated in a control point from a storage medium, and a public key and digital signature authentication unit for comparing a second public key transmitted from the control point with the first public key and for authenticating a digital signature transmitted from the control point using a result of the comparison.

Consistent with a further exemplary embodiment of the present invention, there is provided a home network system for automating a TakeOwnership process. The home network system comprises a control point for generating a public key and a private key and for performing a security console function of providing an access authority for a controlled device by use of the public key, and the controlled device for permitting an access to itself after authentication by use of the public key.

Consistent with a still further exemplary embodiment of the present invention, there is provided a method for automating a TakeOwnership process, the method comprising a) at a control point, generating a public key and a private key and writing the generated public and private keys on a storage medium, b) at the control point, reading again the storage medium after the public key is transmitted to a controlled device, c) authenticating a user using the private key stored on the storage medium, and d) when the result of authenticating confirms that the user is eligible, switching into a security console function.

Consistent with yet another exemplary embodiment of the present invention, there is provided a method for automating a TakeOwnership process. The method comprising a) reading a storage medium storing a first public key generated by a control point and storing the read result, b) receiving a second public key and a digital signature from the control point, c) verifying the received second public key and the digital signature, and d) permitting an access to a controlled device when the second public key and the digital signature are verified.

### BRIEF DESCRIPTION OF THE DRAWINGS

The above and other exemplary objects, features and advantages of the present invention will be more apparent from the following detailed description taken in conjunction with the accompanying drawings, in which:

FIG. 1 shows a conventional password-based TakeOwnership process;

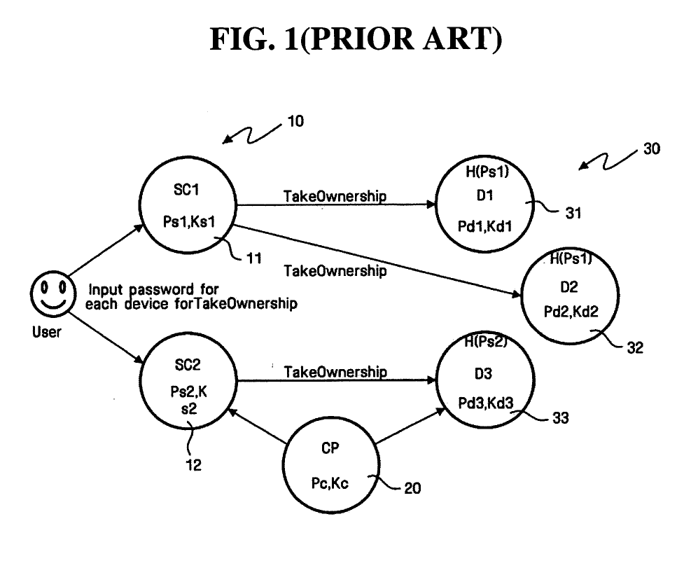

FIG. 2 schematically shows a home network system for automating a TakeOwnership process according to an exemplary embodiment of the present invention;

FIG. 3 shows an initialization process for generation and distribution of keys according to an exemplary embodiment of the present invention;

FIG. 4 shows a switching process of a security console function according to another exemplary embodiment of the present invention;

FIG. 5 shows a process of authenticating and taking ownership according to a further exemplary embodiment of the present invention; and

FIG. 6 shows a method for automating a TakeOwnership process according to a still further exemplary embodiment of the present invention.

### DETAILED DESCRIPTION OF EXEMPLARY EMBODIMENTS

Hereinafter, exemplary, non-limiting embodiments of the present invention will be described with reference to the accompanying drawings.

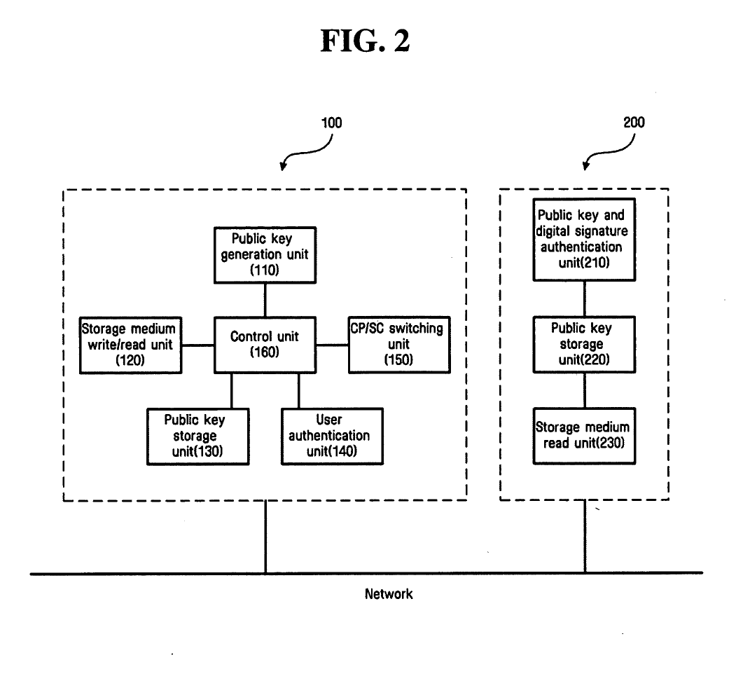

FIG. 2 schematically illustrates a home network system for automating a TakeOwnership process according to an exemplary embodiment of the present invention. The home network system comprises a control point 100 and at least one controlled device 200. The control point 100 includes a public key generation unit 110, a storage medium write/read unit 120, a public key storage unit 130, a user authentication unit 140, a control point/security console (CP/SC) switching unit 150 and a control unit 160. The controlled device 200 includes a public key and digital signature authentication unit 210, a public key storage unit 220 and a storage medium read unit 230.

The public key generation unit 110 of the control point 100 generates a public key (Ps) and a private key (Ks) by employing public key cryptography. Here, the private or secret key is encrypted by a user's password. The public key generated by the public key generation unit 110 is stored in the control point 100 and the controlled device 200 by use of the storage medium. Hereinafter, a “first public key” refers to the public key which the public key generation unit 110 generates and stores in the control point 100 and the controlled device 200, and a “second public key” refers to the public key which is transmitted to the controlled device 200 by the control point 100 for verification in the future.

The storage medium write/read unit 120 writes the public key and the private key generated from the public key generation unit 110 on a storage medium, and reads the public key and the private key from the storage medium. The storage medium may comprise a smart card; alternatively, it may comprise other portable storage medium.

The CP/SC switching unit 150, after implementing a user authentication by use of a private key stored on the storage medium, can select either a security console function or a control point function. The security console function provides an authority to access a specific device and the control point function controls operation of the specific device. The public key storage unit 130 of the control point 100 stores the public key generated from the public key generation unit 110. Here, the public key is used to verify a digital signature created with the private key when the user is authenticated. The user authentication unit 140 creates the digital signature by use of the private key stored on the storage medium, and verifies the digital signature by use of the public key stored on the storage medium.

The storage medium read unit 230 reads the first public key generated in the control point 100 from the storage medium.

The public key storage unit 220 of the controlled device 200 stores the first public key generated from the public key generation unit 110. The first public key is used to verify the security console.

The public key and digital signature authentication unit 210 authenticates the second public key and the digital signature which are received from the control point 100 using the first public key. The public key and digital signature authentication unit 210 permits the control point 100 to access the device so that the control point 100 can edit an access control list (ACL) of its devices (here, the control point functions as a security console).

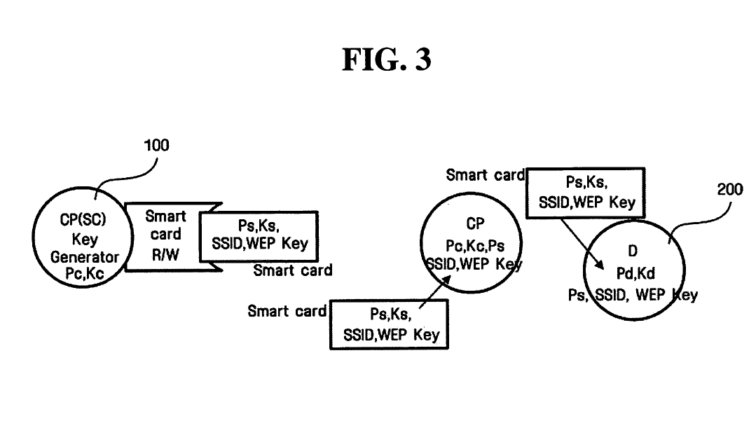

FIG. 3 shows an initialization process for generation and distribution of keys in accordance with an exemplary embodiment of the present invention. A user who purchases at least one new device generates a public key pair of an administrator by use of the public key generation unit 110 and stores the public key pair on a smart card, so as to automatically transmit the public key pair (public key and private key) and security information in the home network. Here, the private key is encrypted using a password of the administrator and is stored on the smart card. Alternatively, information such as SSID or WEP Key can be generated and stored on the smart card for establishment under a wireless environment.

Next, in the case of new devices (CP and D), a user transmits the public key of the administrator (the first public key) to the new devices by using the smart card, for example by contacting the smart card with the new devices. In other words, when a new controlled device 200 is first brought into contact with the smart card, the first public key stored on the smart card is automatically stored to the controlled device 200. Meanwhile, when a new control point 100 is first brought into contact with the smart card, the public key (the first public key) is stored to the control point. Here, since a user transmits his/her public key (the first public key) by use of the smart card, the user can transmit the public key securely. As a result, it is possible to verify the validity of the digital signature as well as authenticate the security console in the next TakeOwnership processes.

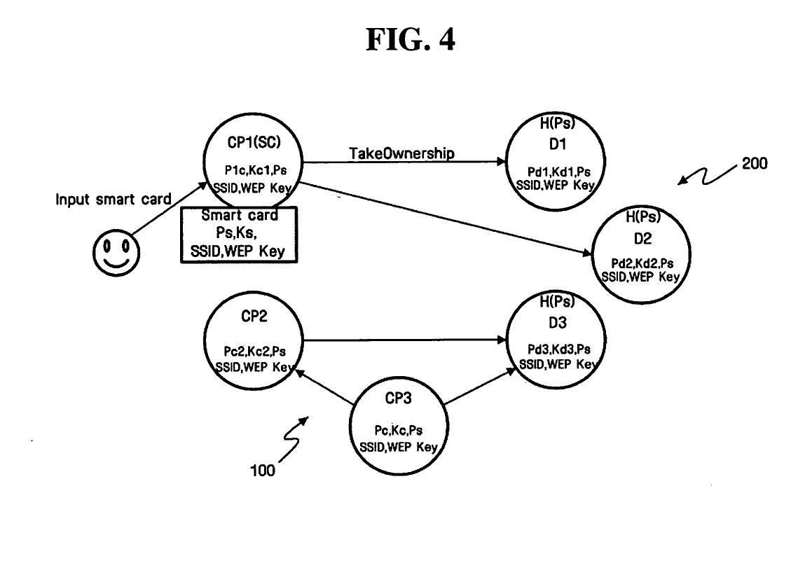

FIG. 4 illustrates a switching process of a security console according to another exemplary embodiment of the present invention. First, when a user brings a smart card into contact with control point 100, the control point 100 requires a password from the user in order to read a private key encrypted and stored as a password of an administrator.

If the password input from user is valid, the private key stored on the smart card can be obtained. Further, the control point 100 creates a digital signature with random numbers by use of the private key. Here, the random numbers are randomly included in each message to prevent the messages from being used by stealth.

Next, the digital signature is verified by use of the public key (the first public key) stored in the initialization process. As a result, if the digital signature is valid, the control point 100 is switched into a security console, and if not, the control point 100 fails to be switched into the security console.

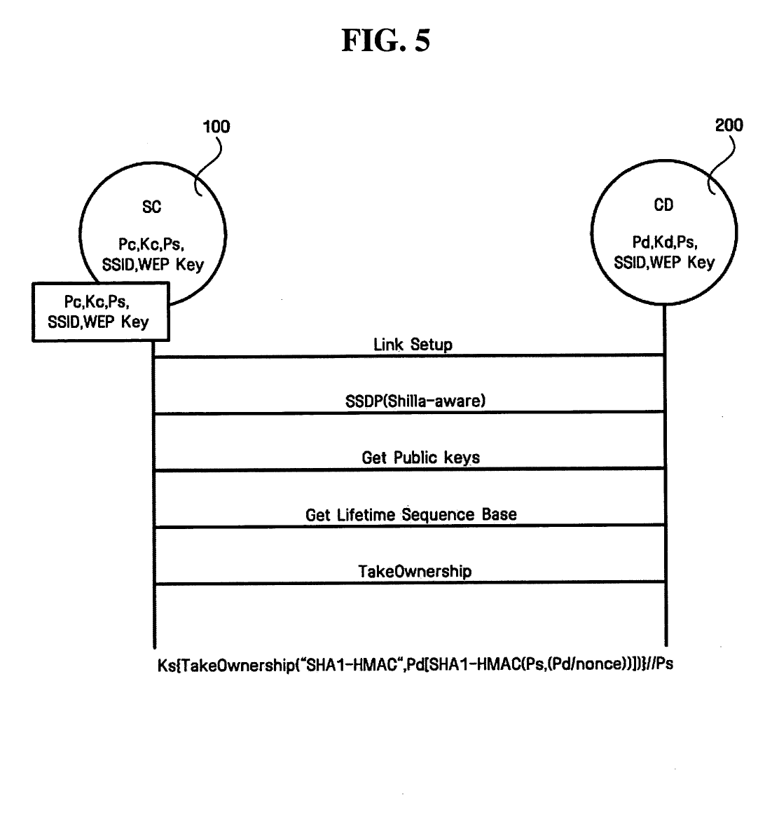

FIG. 5 illustrates a process of authenticating and taking ownership according to a further exemplary embodiment of the present invention. The security console transmits the public key (the second public key) to the controlled device 200 together with its own digital signature so as to take ownership for the controlled device 200. The controlled device 200 determines whether the public key (the second public key) received from the security console is identical to the public key (the first public key) stored in the initialization process.

If both public keys are identical, the controlled device 200 verifies the transmitted digital signature by use of the public key. Then, if the digital signature is valid, the controlled device 200 calculates and stores a hash value for the public key. Further, the security console is allowed to access the controlled device 200. As a result, the security console has an authority to edit an ACL for the controlled device 200.

Meanwhile, if the two public keys are not identical, the security console cannot obtain access to the controlled device 200. Hence, the security console cannot have the authority to edit the ACL for the controlled device 200.

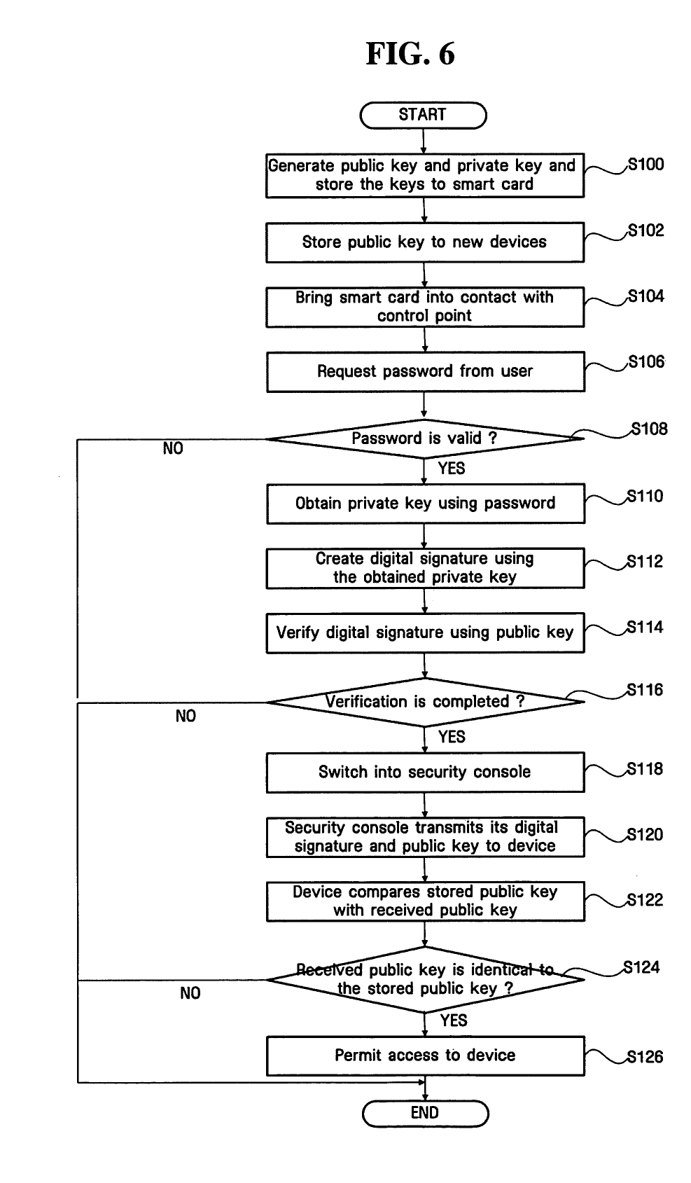

FIG. 6 illustrates a method for automating a TakeOwnership process according to a still further exemplary embodiment of the present invention. A user who purchases at least one new device generates a public key and a private key by use of the public key generation unit 110 in order to automatically transmit security information as well as a public key pair within the home network, and writes the generated public key and private key on a storage medium (hereinafter, referred to as a “smart card”) (step S100). Here, the private key is encrypted by a user's password, and the public and private keys are used in implementing certification of the user.

Next, the public key is stored to the new devices (control point and controlled device) by use of the smart card (step S102). Specifically, when the smart card is brought into contact with the control point 100, the storage medium write/read unit 120 reads the public key written on the smart card and stores the read public key on the public key storage unit 130. Also, when the smart card is brought into contact with the controlled device 200, the storage medium read unit 230 reads the public key written on the smart card and stores the read public key onto the public key storage unit 220.

When the smart card is first brought into contact with the control point 100 or the controlled device 200, the public key stored on the smart card is automatically stored to the control point 100 or the controlled device 200 contacted with the smart card. After the first contact, if the smart card is brought into contact with the control point 100 or the controlled device 200 again, it is required to switch the CP into the SC.

Next, when a user brings the smart card into contact with the control point 100, the control point 100 reads the smart card (step S104) and requests a password from the user in order to read the private key encrypted by the user's password (step S106).

When the user inputs the password, the control point 100 confirms whether the input password is valid. If the input password is valid, the control point 100 can obtain the private key stored on the smart card (step S108 and step S110); if not, the control point 100 cannot obtain the private key. Here, if the control point 100 does not obtain the private key, the switching process of CP/SC is terminated without further proceeding.

Next, the control point 100 creates a digital signature having random numbers by use of the private key (step S112). Here, the random numbers are included in each message made by the control point 100 to prevent the messages from being used by stealth.

The control point 100 verifies the digital signature by use of the stored public key (the first public key) (step S114). As a result, when the digital signature is valid, the control point 100 is switched into the security console. On the contrary, if the digital signature is not valid, the control point 100 fails to be switched into the security console (step S116).

If the control point 100 is switched into the security console, the security console transmits the digital signature and public key (the second public key) to the controlled device 200 so as to take ownership of the controlled device 200, wherein the ACL of the controlled device 200 can be edited (step S118 and step S120).

Next, the controlled device 200 determines whether the public key (the second public key) transmitted from the security console and the public key (the first public key) previously stored on the public key storage unit 220 are identical to each other. If the two public keys are identical, the controlled device 200 verifies the transmitted digital signature by use of the public key (step S122 and step S124).

Then, if the digital signature is valid, the controlled device 200 calculates and stores a hash value for the second public key. Further, the security console is allowed to access the controlled device (step S126). As a result, the security console has an authority to edit the ACL for the controlled device 200.

Meanwhile, if the two public keys are not identical, the security console cannot take ownership for the controlled device 200.

As apparent from the above description, the present invention enables the user to securely operate home network equipment by employing public key cryptography, which creates the digital signature by a private key stored on the smart card and verifies the digital signature by a public key.

Further, in the present invention, it is possible to automatically implement the TakeOwnership process by use of the public key.

In addition, in the present invention, it is not necessary to purchase an additional security console because the control point functions as the security console as well as the control point.

Although various exemplary embodiments of the present invention have been described, those skilled in the art will appreciate that various modifications, additions and substitutions are possible, without departing from the scope and spirit of the invention as disclosed in the accompanying claims.

1. A network device for automating a TakeOwnership process, comprising:
a public key generation unit operable to generate a public key and a private key by employing public key cryptography;
a storage medium write/read unit operable to write the public and private keys on a storage medium and read the public and private keys written on the storage medium; and
a control point/security console (CP/SC) switching unit operable to select one of a security console function and a control point function after authentication of a user using the private key stored on the storage medium, wherein the security console function provides an access authority for a predetermined device, and wherein the control point function controls operation of the predetermined device.

2. The network device of claim 1, further comprising a public key storage unit operable to store the public key generated by the public key generation unit.

3. The network device of claim 1, further comprising a user authentication unit operable to create a digital signature by use of the private key stored on the storage medium, and verify the digital signature by use of the public key stored on the storage medium.

4. The network device of claim 1, wherein the storage medium is a smart card.

5. A network device for automating a TakeOwnership process, comprising:
a storage medium read unit operable to read a first public key generated in a control point from a storage medium; and
a public key and digital signature authentication unit operable to compare a second public key transmitted from the control point with the first public key and if the first public key and the second public key are identical, authenticate a digital signature transmitted from the control point using at least one of the first public key and the second public key.

6. The network device of claim 5, wherein the storage medium comprises a smart card.

7. A home network system for automating a TakeOwnership process, comprising:
a control point operable to generate a public key and a private key and perform a security console function of providing an access authority for a controlled device by use of the public key; and
the controlled device operable to permit an access to the controlled device after authentication by use of the public key.

8. The home network system of claim 7, wherein the control point comprises:
a public key generation unit operable to generate a public key and a private key by employing public key cryptography;
a storage medium write/read unit operable to write the public and private keys on a storage medium and read the public and private keys written on the storage medium; and
a control point/security console (CP/SC) switching unit operable to select one of a security console function and a control point function after authentication of a user using the private key stored on the storage medium, wherein the security console function provides an access authority for a predetermined device, and wherein the control point function controls operation of the predetermined device.

9. The home network system of claim 7, wherein the control point further comprises a public key storage unit operable to store the public key generated from the public key generation unit.

10. The home network system of claim 7, wherein the control point further comprises a user authentication unit operable to create a digital signature by use of the private key stored on the storage medium, and verify the digital signature by use of the public key stored on the storage medium.

11. The home network system of claim 7, wherein the controlled device comprises a storage medium read unit operable to read a first public key from a storage medium on which the first public key generated by the control point is stored; and
a public key and digital signature authentication unit operable to compare a second public key transmitted from the control point with the first public key and if the first public key and the second public key are identical, authenticate a digital signature transmitted from the control point using at least one of the first public key and the second public key.

12. The home network system of claim 7, wherein the storage medium comprises a smart card.

13. A method for automating a TakeOwnership process, comprising:
a) at a control point, generating a public key and a private key and writing the public and private keys on a storage medium;
b) at the control point, reading the storage medium after the public key is transmitted to a controlled device;
c) authenticating a user using the private key stored on the storage medium; and
d) as a result of authentication, if the user is eligible, switching into a security console function.

14. The method of claim 13, wherein d) further includes:
determining whether a password input by the user is valid;
obtaining the private key stored on the storage medium if it is determined that the password is valid,
creating a digital signature using the obtained private key; and
verifying the digital signature using the public key.

15. The method of claim 13, further comprising:
e) at the control point, transmitting a digital signature created by the private key and the public key stored on the storage medium to the controlled device; and
f) obtaining an access authority to the controlled device according to a result of verifying the digital signature and the public key.

16. A method for automating a TakeOwnership process, comprising:
a) reading a storage medium storing a first public key generated by a control point and storing the read result;
b) receiving a second public key and a digital signature from the control point;
c) verifying the second public key and digital signature; and
d) permitting an access to a controlled device if the second public key and the digital signature are verified.

17. The method of claim 16, wherein c) further includes:
comparing the second public key with the first public key stored on the storage medium;
verifying validation of the digital signature using at least one of the first public key and the second public key, if it is determined that the first public key is identical to the second public key as a result of the comparison; and
calculating a hash value for at least one of the first public key and the second public key, if it is verified that the digital signature is valid.
